(19) United States
(12) Patent Application Publication
(10) Pub. No.: US 2023/0155847 A1
(43) Pub. Date: May 18, 2023

(54) FRAUD VERIFICATION DEVICE AND FRAUD DETECTION SYSTEM

(71) Applicant: NEC Solution Innovators, Ltd., Koto-ku, Tokyo (JP)

(72) Inventor: Akira FUKATA, Tokyo (JP)

(73) Assignee: NEC Solution Innovators, Ltd., Koto-ku, Tokyo (JP)

(21) Appl. No.: 17/797,888

(22) PCT Filed: Jan. 20, 2021
(86) PCT No.: PCT/JP2021/001809

§ 371 Date: Aug. 5, 2022

(30) Foreign Application Priority Data
Feb. 21, 2020 (JP) 2020-028430

(51) Int. Cl. H04L 9/00; H04L 9/32

(52) U.S. Cl. CPC H04L 9/50; H04L 9/3236

(57) ABSTRACT

The confirmation block acquisition means 81 acquires a block confirmation transaction which is a transaction including a first merkle root hash calculated from a block header of a block in a target range in a first blockchain and a block number indicating a block of the target range, from a second blockchain. The unauthorized operation verification means 82 identifies a block in the first block chain from the block number included in the acquired confirmation transaction, calculates a second merkle root hash from the block header in the identified block, and compares whether the first merkle root hash and the second merkle root hash match to detect an unauthorized operation on the identified block.

### TECHNICAL FIELD

This invention relates to a fraud verification device, a confirmation generator, a fraud detection system, a fraud verification method, a fraud detection method, and a fraud verification program used to verify and detect fraud committed in a blockchain.

### BACKGROUND ART

In recent years, blockchain has become widely known as one of the distributed ledger technologies (DLT: Distributed Ledger Technology). Blockchain is a technology for storing data by generating units of data called blocks and connecting each block.

The header of each block contains a hash value calculated from the transaction history (transactions) in the block, which allows the correct combination of transaction history to be verified. The hash value calculated from the previous block header is also stored, which can be used to verify the validity of the logical connection with the previous block.

Blockchains can be classified into three main forms, depending on how the block approvers are selected and how they are structured (i.e., the validators in reaching consensus).

The first is a form of blockchain known as a public blockchain. In a public blockchain, there is no centralized authority, and the risk of fraud is eliminated by providing a consensus algorithm such as PoW (Proof of Work). Because of these characteristics, the public blockchain is generally large network with an unspecified number of nodes, as there are no restrictions on participation.

The second is a form of blockchain known as a private blockchain. The private blockchain is small network with limited participation and only certain nodes can join. Because the number of participating nodes is smaller than that of public blockchain, transactions (approvals) generally take less time.

The third is a form of blockchain known as a consortium blockchain. Like the private blockchain, consortium blockchain has fewer participating nodes than the public blockchain, so the transaction time is generally shorter. Furthermore, the consortium blockchain is more reliable network than the private blockchain because consensus is formed by multiple organizations.

Additionally, Patent Literature 1 describes a system for detecting tampering in the blockchain. In the system described in Patent Literature 1, the proof of existence of the terminal object is stored in an external system. Therefore, if the history of a certain object is re-created or a terminal object is replaced, the tampering can be detected by using the proof of existence in the external system.

### CITATION LIST

### Patent Literature

Patent Literature 1: Japanese Patent No. 6618138

### SUMMARY OF INVENTION

### Technical Problem

As described above, the private and consortium blockchains are smaller than the public blockchain, with only a few dozen nodes comprising the chain. Therefore, if multiple malicious participants collude to falsify data, the possibility exists that such fraud may not be detected.

The system described in Patent Literature 1 does not consider collusion and data tampering among blockchain participants in the first place, and is not capable of detecting such fraud.

It is therefore an exemplary object of the present invention to provide a fraud verification device, a fraud detection system, a fraud verification method, a fraud detection method, a fraud verification program capable of detecting tampering with data performed on a blockchain, and a confirmation generator that generates a confirmation used for the detection.

### Solution to Problem

A fraud verification device including: a confirmation block acquisition means that acquires a block confirmation transaction which is a transaction including a first merkle root hash calculated from a block header of a block in a target range in a first blockchain and a block number indicating a block of the target range, from a second blockchain which is a blockchain in which the block confirmation transaction is registered and which is different from the first blockchain; and an unauthorized operation verification means that identifies a block in the first block chain from the block number included in the acquired confirmation transaction, calculates a second merkle root hash from the block header in the identified block, and compares whether the first merkle root hash and the second merkle root hash match to detect an unauthorized operation on the identified block.

A confirmation generator according to the present invention including: a confirmation block generation means that calculates a merkle root hash from a block header of a block in a target range in a first blockchain, and generates a block confirmation transaction which is a transaction including a block number indicating a block of the target range and the calculated merkle root hash; and a registration request means that sends a transaction requesting registration of the block confirmation transaction to a second blockchain different from the first blockchain.

A fraud detection system according to the present invention including: a confirmation block generation means that calculates a first merkle root hash from a block header of a block in a target range in a first blockchain, and generates a block confirmation transaction which is a transaction including a block number indicating a block of the target range and the calculated first merkle root hash; a registration request means that sends a transaction requesting registration of the block confirmation transaction to a second blockchain different from the first blockchain; a confirmation block acquisition means that acquires the block confirmation transaction from the second blockchain; and an unauthorized operation verification means that identifies a block in the first block chain from the block number included in the acquired confirmation transaction, calculates a second merkle root hash from the block header in the identified block, and compares whether the first merkle root hash and the second merkle root hash match to detect an unauthorized operation on the identified block.

A fraud verification method according to the present invention including: acquiring a block confirmation transaction which is a transaction including a first merkle root hash calculated from a block header of a block in a target range in the first blockchain and a block number indicating a block of the target range, from a second blockchain which is a blockchain in which the block confirmation transaction is registered and which is different from the first blockchain; and identifying a block in the first block chain from the block number included in the acquired confirmation transaction, calculating a second merkle root hash from the block header in the identified block, and comparing whether the first merkle root hash and the second merkle root hash match to detect an unauthorized operation on the identified block.

A fraud detection method according to the present invention including: calculating a first merkle root hash from a block header of a block in a target range in a first blockchain, and generating a block confirmation transaction which is a transaction including a block number indicating a block of the target range and the calculated first merkle root hash; sending a transaction requesting registration of the block confirmation transaction to a second blockchain different from the first blockchain; acquiring the block confirmation transaction from the second blockchain; and identifying a block in the first block chain from the block number included in the acquired confirmation transaction, calculating a second merkle root hash from the block header in the identified block, and comparing whether the first merkle root hash and the second merkle root hash match to detect an unauthorized operation on the identified block.

A fraud verification program according to the present invention causes the computer to perform: confirmation block acquisition processing of acquiring a block confirmation transaction which is a transaction including a first merkle root hash calculated from a block header of a block in a target range in the first blockchain and a block number indicating a block of the target range, from a second blockchain which is a blockchain in which the block confirmation transaction is registered and which is different from the first blockchain; and unauthorized operation verification processing of identifying a block in the first block chain from the block number included in the acquired confirmation transaction, calculating a second merkle root hash from the block header in the identified block, and comparing whether the first merkle root hash and the second merkle root hash match to detect an unauthorized operation on the identified block.

### Advantageous Effects of Invention

The invention allows the detection of unauthorized operations on data performed in the blockchain.

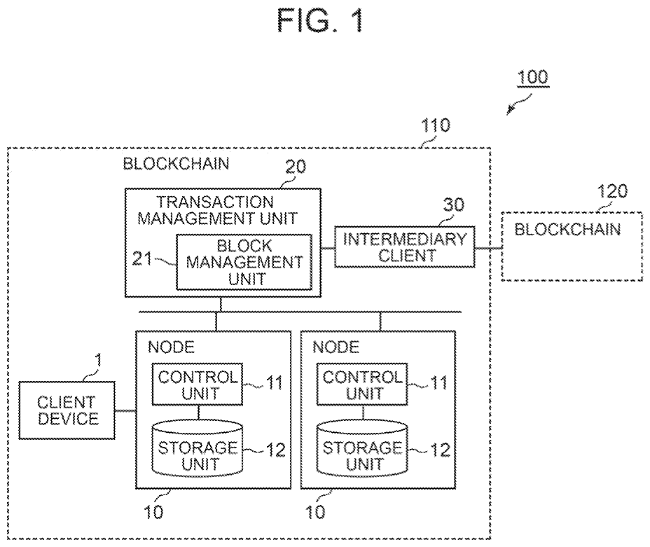

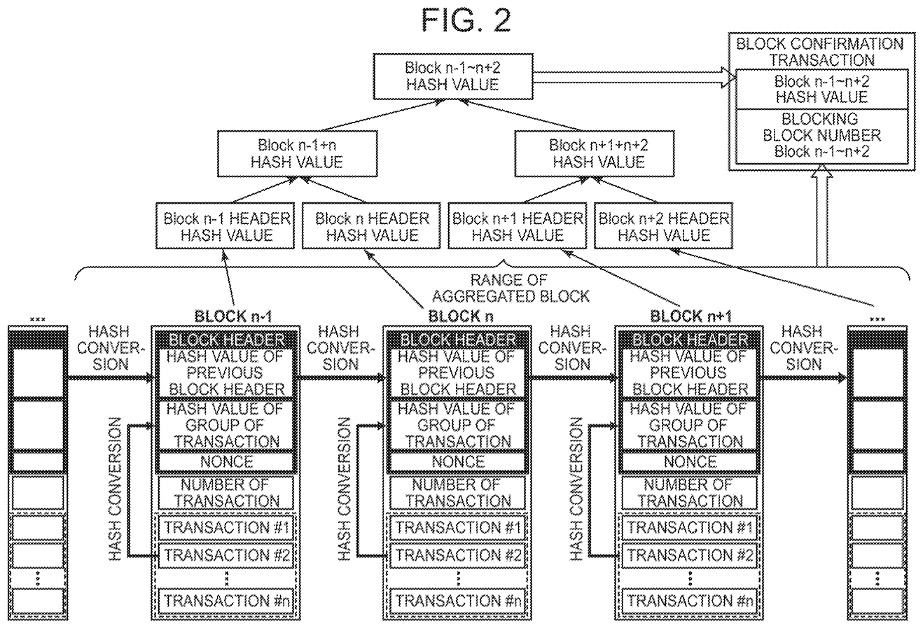

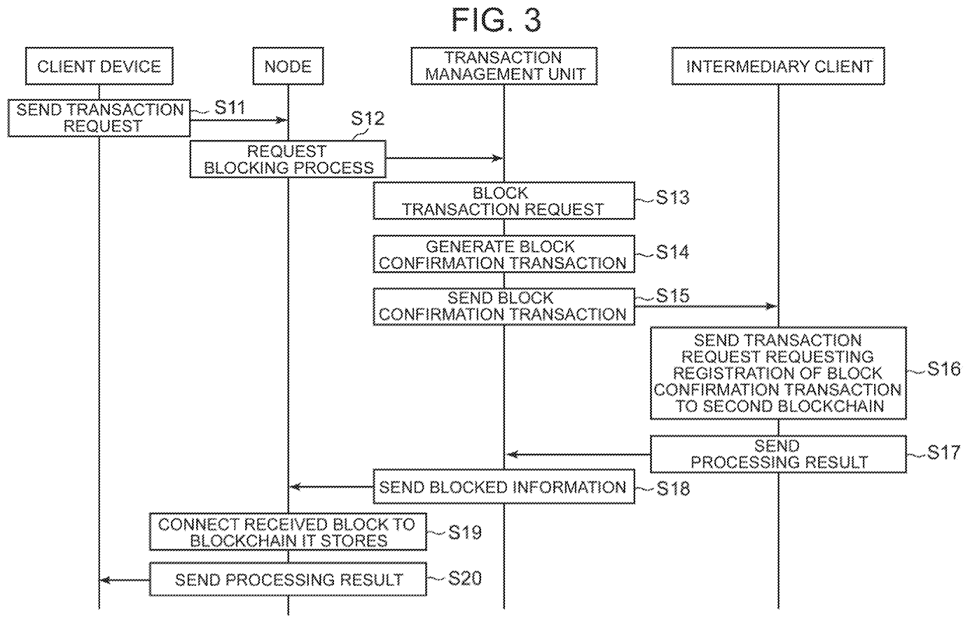

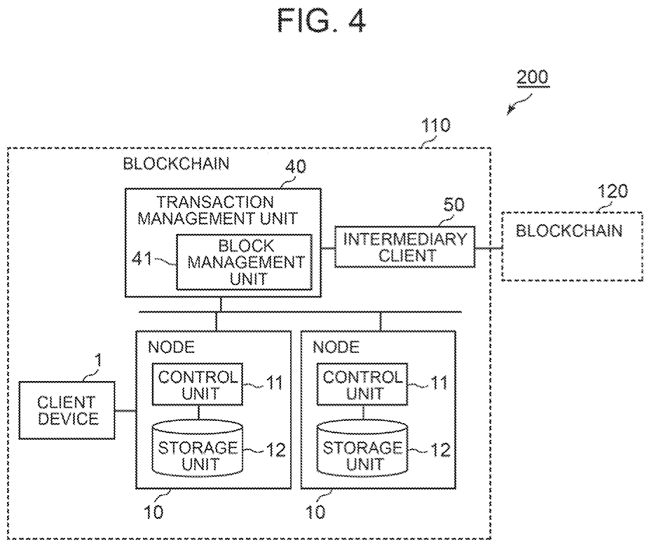

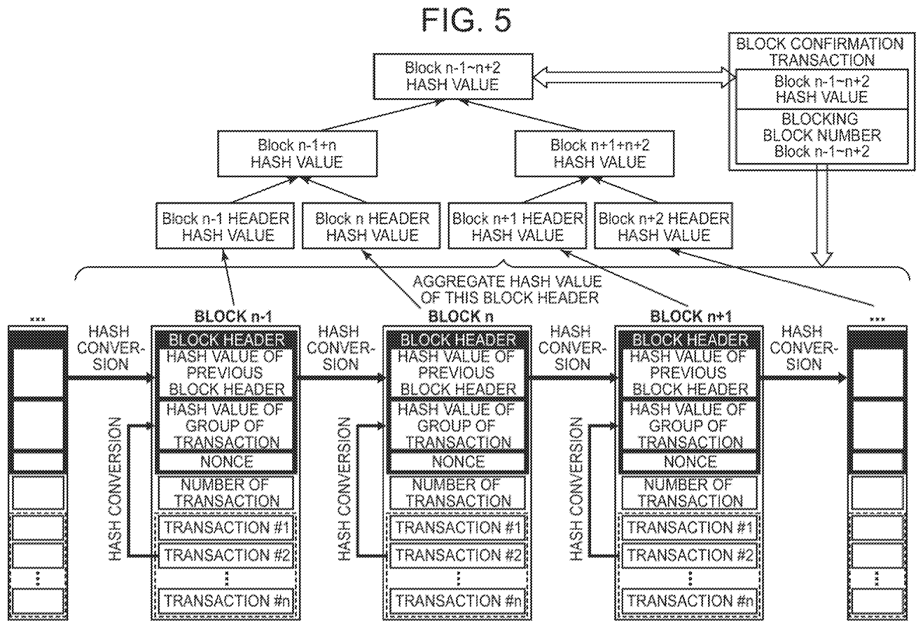

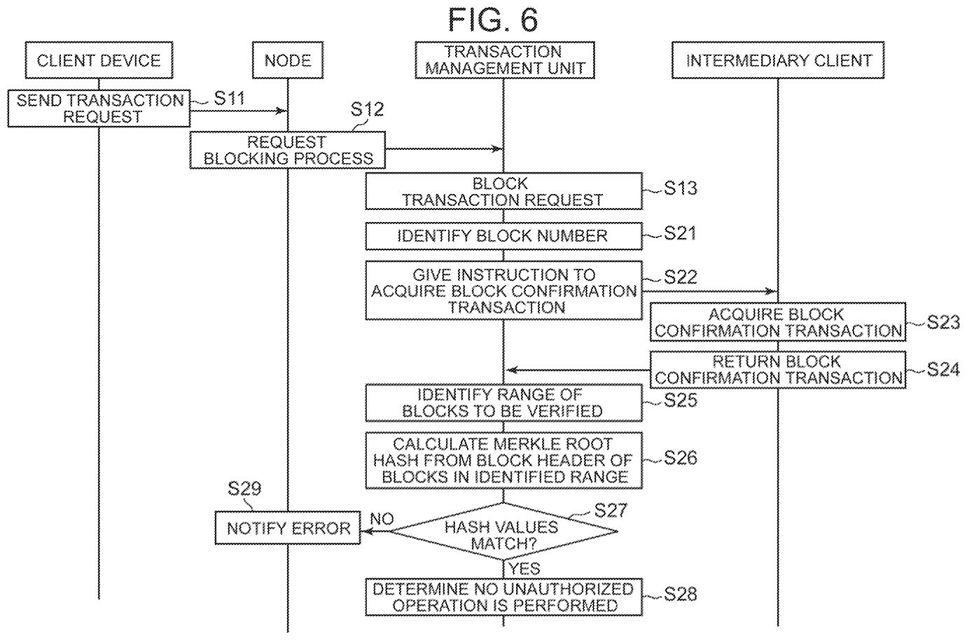

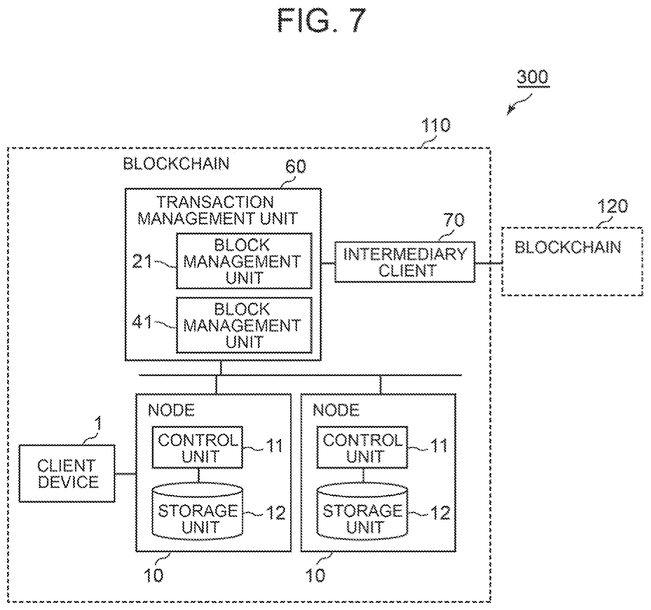

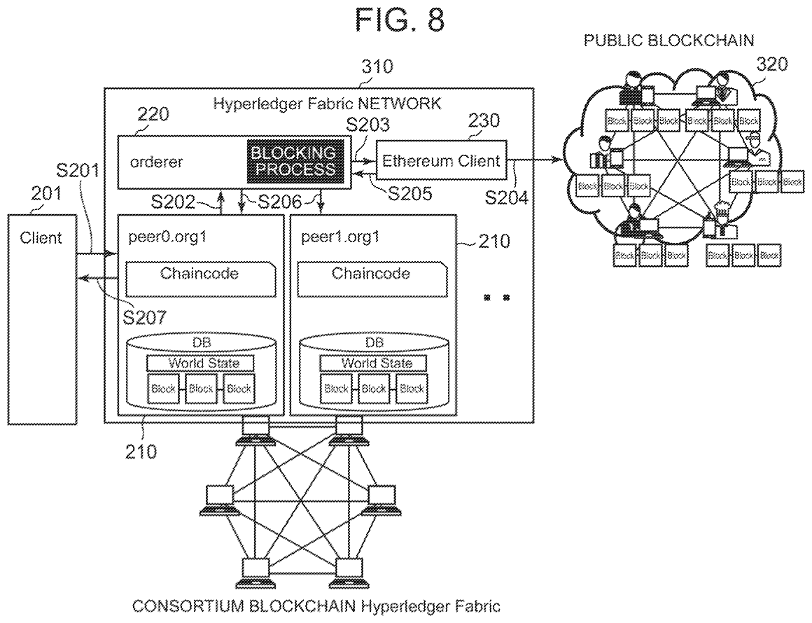

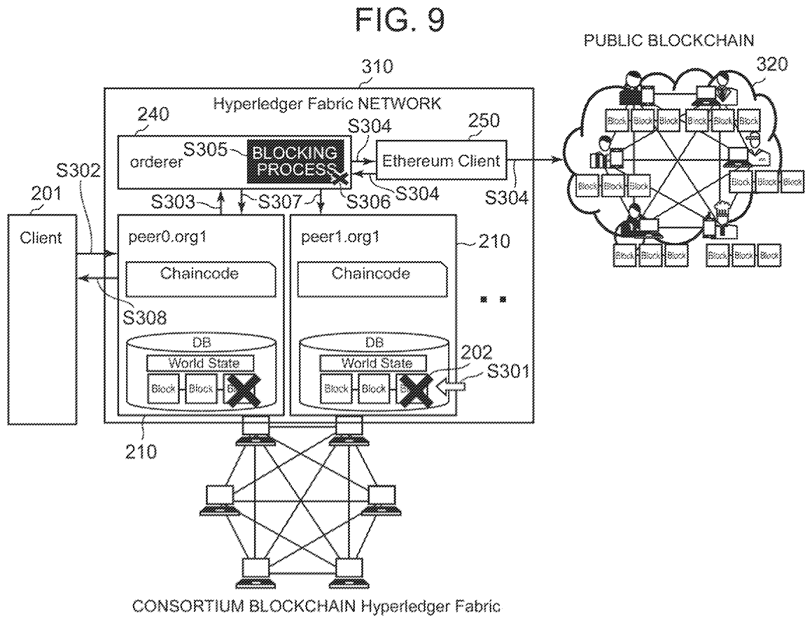

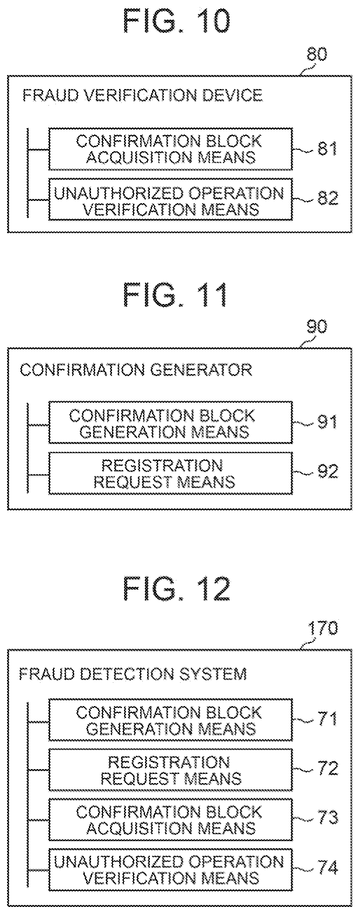

### BRIEF DESCRIPTION OF DRAWINGS

[FIG. 1] It depicts an explanatory diagram illustrating a first exemplary embodiment of a fraud detection system according to the present invention.

[FIG. 2] It depicts an explanatory diagram illustrating an example of the process of generating a block confirmation transaction.

[FIG. 3] It depicts an explanatory diagram illustrating an example of the operation of the fraud detection system of the first exemplary embodiment.

[FIG. 4] It depicts an explanatory diagram illustrating a second exemplary embodiment of a fraud detection system according to the present invention.

[FIG. 5] It depicts an explanatory diagram illustrating an example of block verification.

[FIG. 6] It depicts an explanatory diagram illustrating an example of the operation of the fraud detection system of the second exemplary embodiment.

[FIG. 7] It depicts an explanatory diagram illustrating a third exemplary embodiment of a fraud detection system according to the present invention.

[FIG. 8] It depicts an explanatory diagram illustrating a concrete example of the process of registering a confirmation.

[FIG. 9] It depicts an explanatory diagram illustrating a concrete example of verifying unauthorized operations.

[FIG. 10] It depicts a block diagram illustrating an overview of the fraud verification device according to the present invention.

[FIG. 11] It depicts a block diagram illustrating an overview of the confirmation generator according to the present invention.

[FIG. 12] It depicts a block diagram illustrating an overview of the fraud detection system according to the present invention.

### DESCRIPTION OF EMBODIMENTS

Hereinafter, an exemplary embodiment of the present invention will be described with reference to appended drawings.

### Exemplary Embodiment 1

The first exemplary embodiment describes a process of registering a confirmation for detection of unauthorized operation. FIG. 1 is an example configuration of the first exemplary embodiment of the fraud detection system. The fraud detection system 100 of this exemplary embodiment includes a client device 1, a plurality of nodes 10, a transaction management unit 20 and an intermediary client 30.

The client device 1, a plurality of the nodes 10, and the transaction management unit 20 operate as components of a blockchain 110. Hereafter, the blockchain 110 containing the client device 1, a plurality of the nodes 10, the transaction management unit 20, and the intermediary client 30 is hereinafter referred to as a first blockchain.

In this exemplary embodiment, the first blockchain is assumed to be a small-scale network with a few dozen nodes comprising a chain, such as a private blockchain or a consortium blockchain. Examples of such blockchains include Hyperldger Fabric, Corda, and Quorum. In the following explanation, Hyperldger Fabric will be used as a specific example of the first blockchain, but the aspect of the first blockchain is not limited to Hyperldger Fabric.

The intermediary client 30, described below, also operates as a component of a larger blockchain 120, such as a public blockchain. The blockchain 120 containing the intermediary client 30 is hereinafter referred to as a second blockchain. The second blockchain is a different blockchain from the first blockchain. Examples of such blockchains include Ethereum, NEM, and EOS. In the following explanation, Ethereum will be used as a specific example of the second blockchain, but the aspect of the second blockchain is not limited to Ethereum. The details of the second blockchain are described below.

The client device 1 creates a transaction request (a transaction) in the blockchain 110, and is a device that sends the created transaction request to one of a plurality of the nodes 10. The client device 1 is a device called a client, node, wallet, etc., although there are various designations depending on the blockchain in which it participates. For example, in the case of Hyperdger Fabric, the client device 1 corresponds to a client. The client device 1 may create the transaction request according to the blockchain in which it participates.

The node 10 consists of multiple units in the blockchain 110, accepts and processes received transaction requests, and stores the blockchain data generated as a result of the processing. For example, in the case of Hyperldger Fabric, the node 10 corresponds to a peer. Although FIG. 1 shows a case of two nodes 10, the number of nodes is not limited to two and may be three or more.

Node 10 includes a control unit 11 and a storage unit 12.

The control unit 11 performs verification and execution on the received transaction request. Each process executed by the control unit 11 is defined according to the blockchain 110, and the control unit 11 may execute each process according to the blockchain 110 used and the transaction request received, and notify the client device 1 of the processing results. For example, in the case of Hyperldger Fabric, the control unit 11 may execute the processing for the transaction request according to the chain code (program) in which the business logic is implemented.

The storage unit 12 stores blockchain data, commonly referred to as Ledger. For example, in the case of Hyperldger Fabric, the ledger includes a World State and multiple blocks (blockchains). Each block includes a block header that contains metadata about the block as well as multiple transaction requests. The block header includes a hash value of the previous block, a hash value of a transaction group (Markle root), and a nonce. In addition to these, the block header also includes timestamps and bits.

The transaction management unit 20 collectively creates a block for transaction requests. Specifically, the transaction management unit 20 generates a block in which transaction requests are ordered and put together, and broadcasts the generated block to each of the nodes 10. For example, in the case of Hyperldger Fabric, the transaction management unit 20 corresponds to an orderer. Each process performed by the transaction management unit 20 is also defined according to the blockchain 110, and the transaction management unit 20 may execute each process according to the blockchain 110 used.

The transaction management unit 20 in this exemplary embodiment also includes a block management unit 21. The block management unit 21 calculates a merkle root hash from the block headers of the blocks in a target range. Specifically, the block management unit 21 aggregates the hash values of the block headers in the blocks of the target range in a Markle tree and calculates one merkle root hash. Furthermore, the block management unit 21 generates a transaction (hereinafter referred to as a block confirmation transaction) that includes a block number indicating the block in an aggregated range and the marked root hash.

The target range is determined according to the timing of block generation in the first blockchain and the timing of block generation in the second blockchain. In this exemplary embodiment, it is assumed that the first blockchain is a small-scale network such as a private blockchain or consortium blockchain and the second blockchain is a large-scale blockchain such as a private blockchain. Therefore, the target range may be the number of blocks generated in the first blockchain at intervals when blocks are generated in the second blockchain.

For example, if the second blockchain is Ethereum, the interval when blocks are generated is 15 seconds. Here, if blocks are generated at intervals of 1 second in the first blockchain, the target range of blocks may be 15 blocks.

FIG. 2 is an example of the process of generating a block confirmation transaction. The block management unit 21 collects hash values of block headers calculated at the time of block generation for the number of blocks to be aggregated. The example shown in FIG. 2 indicates that hash values of block headers from block n−1 to block n+2 have been collected.

Next, the block management unit 21 calculates the hash value again from the hash values of the block headers in adjacent blocks. Furthermore, the block management unit 21 repeats the process of calculating hash values again from the calculated adjacent hash values until a single hash value is acquired. If there are no more adjacent hash values by the time a single hash value is acquired, the block management unit 21 may calculate the hash value again using the same hash value. Then, the block management unit 21 uses the hash value calculated until there is only one hash value as the merkle root hash.

The example shown in FIG. 2 indicates that a hash value (block n−1+n) is calculated from the hash value of the block header of block n−1 and the hash value of the block header of block n, a hash value (block n+1+n+2) is calculated from the hash value of the block header of block n+1 and the hash value of the block header of block n+2. Furthermore, the example shown in FIG. 2 that a hash value (blocks n−1 to n+2) is calculated again from the hash value (blocks n−1+n) and the hash value (blocks n+1+n+2), and this hash value is used as merkle root hash.

In the example shown in FIG. 2, the block numbers of the blocks (blocks n−1 to n+2) from which this merkle root hash is calculated are the block numbers of the blocks in the aggregated range. This block number is used in the hash value calculation process described below.

In this way, the block management unit 21 calculates one merkle root hash from the block headers in the target range of blocks, so that if tampering is later performed on a registered transaction, the hash values will not match, and the tampering can be detected.

The block management unit 21 sends the generated block confirmation transaction to the intermediary client 30.

In this exemplary embodiment, the case in which the block management unit2l is configured as part of the transaction management unit 20 is described, but the block management unit 21 may be provided separately from the transaction management unit 20. In that case, the block management unit 21 may receive the output from the transaction management unit 20 and perform each of the processes described above.

The intermediary client 30 is a device that creates a transaction request in the blockchain 120 and sends the created transaction request to the node (not shown) in the blockchain 120. In other words, the intermediary client 30 is a device that operates as a client (node, wallet) in the blockchain 120.

In particular, the intermediary client 30 in this exemplary embodiment sends a transaction requesting the registration of a block confirmation transaction to the blockchain 120 (specifically, the node of the blockchain 120). Thereafter, the transaction request is processed according to the specifications of the blockchain 120, and the intermediary client 30 receives the processing results of the transaction request.

Note that it takes time for a block containing transaction history to be generated in the blockchain. For example, in the case of Ethereum, it takes about 15 seconds to generate a block. Therefore, the intermediary client 30 may receive a notification that registration is complete as a processing result.

The second blockchain can be any blockchain that can include a block confirmation transaction in the transaction request, as long as this block confirmation transaction is difficult to tamper with, such as a public blockchain. By registering a block confirmation transaction in such a large blockchain 120, the tampering of this transaction itself can be inhibited.

Thus, in this exemplary embodiment, the block management unit 21 generates a block confirmation transaction, and the intermediary client 30 sends the generated block confirmation transaction to the second blockchain, then the device including the block management unit 21 and the intermediary client 30 can be referred to as a confirmation generation device.

The transaction management unit 20 (more precisely, the block management unit 21) and the intermediary client 30 are implemented by a processor (e.g., CPU (Central Processing Unit) or GPU (Graphics Processing Unit) of a computer that operates in accordance with a program (the confirmation generation program). For example, the program may be stored in the storage unit 12, and the processor may read the program and operate as the transaction management unit 20 (more precisely, the block management unit 21) and the intermediary client 30 in accordance with the program. The functions of the confirmation generator may also be provided in the form of Software as a Service (SaaS).

Further, transaction management unit 20 (more precisely, the block management unit 21) and the intermediary client 30 may each be implemented by dedicated hardware. In addition, some or all of the components of each device may be realized by general-purpose or dedicated circuits (circuitry), processors, etc., or a combination thereof. They may be configured by a single chip or by multiple chips connected via a bus. Part or all of each component of each device may be realized by a combination of the above-mentioned circuits, etc. and a program.

When some or all of the components of the confirmation generator are realized by multiple information processing devices or circuits, the multiple information processing devices or circuits may be centrally located or distributed. For example, the information processing devices and circuits may be realized as a client-server system, a cloud computing system, or the like, each of which is connected via a communication network.

An operation of the fraud detection system of the present exemplary embodiment will now be described. FIG. 3 is an example of the operation of the fraud detection system 100 of this exemplary embodiment. The client device 1 creates a transaction request and sends it to the node 10 (step S11). The control unit 11 of the node 10 performs verification and execution on the received transaction request, and requests transaction management unit 20 to process the blocking of the transaction request (step S12). The transaction management unit 20 blocks the transaction request (step S13). The block management unit 21 also generates a block confirmation transaction (step S14) and sends the generated block confirmation transaction to the intermediary client 30 (step S15).

The intermediary client 30 sends a transaction request to the blockchain 120 requesting registration of the block confirmation transaction (step S16). The intermediary client 30 sends a processing result from blockchain 120 to transaction management unit 20 (step S17), then the transaction management unit 20 sends the blocked information to each node 10 (step S18). Each node 10 connects the received block to the blockchain it stores (step S19) and sends a processing result to the client device 1 (step S20).

The process of step S14 and step S15 illustrated in FIG. 3 correspond to the process performed by the confirmation generator described above (confirmation generation process).

As described above, in this exemplary embodiment, the block management unit 21 calculates the merkle root hash from the block header in the target range of blocks in the first blockchain, and generates the block confirmation transaction including a block number indicating a block of the range and the calculated merkle root hash. The intermediary client 30 then sends a transaction requesting registration of the block confirmation transaction to the second blockchain. Thus, even if data tampering has occurred in the first blockchain, the tampering can be detected by the block confirmation transaction registered in the second blockchain.

In addition, by determining the range of blocks for which the merkle root hash is to be generated according to the timing of block generation in the first blockchain and the timing of block generation in the second blockchain, it is possible to adjust for the difference in speed of block generation in the two blockchains.

In addition, fees generally increase with the number of transaction requests sent to the blockchain. In this exemplary embodiment, a single merkle root hash is generated from the hash values of the block headers of multiple blocks to generate a block confirmation transaction, which also reduces the fees in the second blockchain.

### Exemplary Embodiment 2

Next, a second exemplary embodiment of the present invention will be described. The second exemplary embodiment describes the process of detecting unauthorized operation based on the confirmation registered in the first exemplary embodiment. FIG. 4 is an example configuration of a second exemplary embodiment of the fraud detection system. The fraud detection system 200 of this exemplary embodiment includes a client device 1, a plurality of nodes 10, a transaction management unit 40, and intermediary client 50.

In other words, the fraud detection system 200 of the second exemplary embodiment differs from the fraud detection system 100 of the first exemplary embodiment in that the fraud detection system 200 includes the transaction management unit 40 instead of the transaction management unit 20 and the intermediary client 50 instead of the intermediary client 30. Other than that, the configuration of client device 1 and a plurality of nodes 10 is the same as in the first exemplary embodiment, so the description is omitted.

As in the first exemplary implementation, the transaction management unit 40 creates a block of transaction requests together. The transaction management unit 40 in this exemplary embodiment also includes a block management unit 41. As in the first exemplary embodiment, the block management unit 41 may be provided separately from the transaction management unit 40. The function of the block management unit 41 is described below.

The intermediary client 50, based on instructions from the transaction management unit 40 (more specifically, the block management unit 41), described below acquires a block confirmation transaction from blockchain 120 (i.e., the second blockchain). Specifically, the intermediary client 50 identifies, from the block number of the specified block, the block confirmation transaction that includes the merkle root hash calculated based on the block header of the block. The intermediary client 50 may acquire the block confirmation transaction based on the specifications of the second blockchain.

The intermediary client 50 then sends the information on the identified block confirmation transaction to the transaction management unit 40 (more specifically, the block management unit 41). The intermediary client 50 may send the block number of the aggregated range of blocks and the merkle root hash from the information of the specified block confirmation transaction to the transaction management unit 40.

The block management unit 41 identifies the block number of the block to be used for verification from the transaction request and gives instructions to the intermediary client 50 to acquire the block confirmation transaction. Then, the block management unit 41 extracts the range of blocks to be verified from the information in the acquired block confirmation transaction (more specifically, the block numbers of the blocks in the aggregated range), and identifies the blocks in the first blockchain.

Next, the block management unit 41 calculates the merkle root hash again from the block headers of the blocks in the identified range. The method of calculating the merkle root hash is the same as the method used by the block management unit 21 in the first exemplary embodiment. Then, the block management unit 41 compares the newly calculated merkle root hash with the merkle root hash acquired from the block confirmation transaction to detect unauthorized operations.

FIG. 5 is an explanatory diagram illustrating an example of block verification. The example shown in FIG. 5 indicates that block numbers (blocks n−1 to n+2) are identified as the range of blocks to be verified. The block management unit 41 identifies the blocks in the range indicated by the block number, aggregates the hash values of the block headers of the identified blocks in a merkle tree, and generates a single merkle root hash. The block management unit 41 then compares the newly calculated merkle root hash with the merkle root hash acquired from the block confirmation transaction. If the hash values do not match, the block management unit 41 determines that unauthorized operation (tampering) is performed in a transaction in one of the blocks.

If the hash values do not match, the transaction management unit 40 determines that an unauthorized operation is performed and notifies the node 10 of the error. At this time, the node 10 which received the transaction request from client device 1 notifies that client device 1 of the error.

Thus, in this exemplary embodiment, the intermediary client 50 acquires the block confirmation transaction from the second blockchain, and the block management unit 41 acquires the block confirmation verifying the unauthorized operation based on the transaction. For this reason, the device including the block management unit 41 and the intermediary client 50 can be referred to as a fraud verification device.

The transaction management unit 40 (more precisely, the block management unit 41) and the intermediary client 50 are implemented by a processor of a computer that operates in accordance with a program (the confirmation generation program).

Next, an operation of the fraud detection system of the present exemplary embodiment will now be described. FIG. 6 is an explanatory diagram illustrating an example of the operation of the fraud detection system 200 of this exemplary embodiment. The process from receiving a transaction request by client device 1 to blocking is the same as the process from step S11 to step S13.

The block management unit 41 identifies the block number of the block to be used for verification (step S21) and gives instructions to the intermediary client 50 to acquire a block confirmation transaction (step S22). The intermediary client 50 acquires a block confirmation transaction from the second blockchain based on the instruction from the block management unit 41 (step S23) and returns it to the block management unit 41 (step S24).

The block management unit 41 identifies the range of blocks to be verified from the range of block numbers acquired (step S25). Then, the block management unit 41 calculates the merkle root hash again from the block headers of the blocks in the identified range (step S26), and compares the hash to match the merkle root hash acquired from the block confirmation transaction (step S27).

If the hash values match (Yes in step S27), the block management unit 41 determines that no unauthorized operation is performed (step S28). On the other hand, if the hash values do not match (No in step S27), the block management unit 41 determines that an unauthorized operation is performed, and the node 10 notifies client device 1 of the error (step S29).

The process from step S21 to step S29 illustrated in FIG. 6 correspond to the process performed by the fraud verification device described above (fraud verification process).

As described above, in this exemplary embodiment, the intermediary client 50 acquires a block confirmation transaction from the second blockchain, and the block management unit 41 identifies the block in the first block chain from the block number included in the confirmation transaction and calculates the merkle root hash from the block header in the identified block. Then, the merkle root hash included in the block confirmation transaction is compared with the calculated merkle root hash to see if they match, and unauthorized operations on the identified block are detected. Thus, tampering with data in the blockchain can be detected.

### Exemplary Embodiment 3

Next, a third exemplary embodiment of the present invention will be described. In the first exemplary embodiment, it is described how the fraud detection system 100 generates a confirmation (block confirmation transaction) for verification, and in the second exemplary embodiment, it is described how the fraud detection system 200 verifies data tampering using the confirmation. The process of generating the confirmation and the process of verifying the unauthorized operation may be realized in a single system.

FIG. 7 is an example configuration of a third exemplary embodiment of the fraud detection system. The fraud detection system 300 in this exemplary embodiment includes a client device 1, a plurality of nodes 10, a transaction management unit 60, and an intermediary client 70.

The transaction management unit 60 includes the block management unit 21 of the first exemplary embodiment and the block management unit 41 of the second exemplary embodiment. The intermediary client 70 combines the functions of the intermediary client 30 of the first exemplary embodiment and the intermediary client 50 of the second exemplary embodiment. As in the first exemplary embodiment and second exemplary embodiment, the block management unit 21 and the block management unit 41 may be provided separately from the transaction management unit 60.

With this configuration, even if data tampering occurs in the first blockchain, the tampering can be detected by a block confirmation transaction registered in the second blockchain.

Next, specific configuration examples of the fraud detection system of the above exemplary embodiment will be described. In the following explanation, the case in which Hyperldger Fabric is used for the first blockchain and Ethereum is used for the second blockchain is illustrated.

FIG. 8 is an explanatory diagram illustrating a concrete example of the process of registering a confirmation. In the example shown in FIG. 8, a client 201 is outside the Hyperldger Fabric network 310, but the client 201 may be included in the Hyperldger Fabric network 310.

The client 201 creates a transaction request and sends it to the first blockchain (Hyperldger Fabric network 310) (step S201). After executing the process in response to the transaction request, a peer 210 requests an orderer 220 to perform the blocking process (step S202). The orderer 220 generates a block confirmation transaction along with the blocking process and sends it to Ethereum client 230 (step S203). The Ethereum client 230 records the block confirmation transaction in a second blockchain (Ethereum network 320) (step S204) and returns the result to the orderer 220 (step S205). The orderer 220 sends the block information to each of the 210 peers (step S206). The peer connects the block to its own blockchain and returns the result to the client201 (step S207).

FIG. 9 is an explanatory diagram illustrating a concrete example of verifying unauthorized operations. The example shown in FIG. 9 also shows that the client 201 is outside the Hyperldger Fabric network 310, but the client 201 may be included in the Hyperldger Fabric network 310. Here, it is assumed that malicious users are colluding to rewrite a block 202 (step S301).

The client 201 creates a transaction request and sends it to the first blockchain (Hyperldger Fabric network 310) (step S302). After executing the process in response to the transaction request, the peer 210 requests an orderer 240 to perform the blocking process (step S303). An ethereum client 250 reads the block confirmation transaction from the second blockchain (Ethereum network 320) (step S304). The orderer 240 generates a hash value for the target block based on the block confirmation transaction (step S305).

Because the block 202 is rewritten, the generated hash value does not match the value of the block confirmation transaction (step S306). Therefore, the orderer 240 returns an error to the peer 210 (step S307), and the peer 210 returns the error to the client201 (step S308).

Next, the specific process of detecting document tampering using this fraud detection system is described. Here, the first blockchain is a consortium blockchain and the second blockchain is a public blockchain.

For example, it is assumed that a transaction A in the first blockchain contained data that can prove that a document is not tampered with. When it finds that transaction A is in block number 10, the intermediary client 50 acquires a block confirmation transaction from the public blockchain (the second blockchain) that generates a hash value based on the block number 10.

Here, if the data in block 10 is found to be contained in block 1100 of the public blockchain, the intermediary client 50 retrieves the merkle root hash from the block confirmation transaction contained in block 1100 of the public blockchain. Meanwhile, the block management unit 41 calculates the merkle root hash again from the block numbers of the blocks in the aggregated range. If these two hash values match, it can be determined that the document has not been tampered with. As described above, since the judgment process is performed in the first blockchain, the client device 1 basically does not need to be aware of the internal process.

The following is an overview of the invention. FIG. 10 is a block diagram illustrating an overview of the fraud verification device according to the present invention. The fraud verification device 80 (e.g., the fraud verification device of the second exemplary embodiment described above) according to the present invention includes: a confirmation block acquisition means 81 (e.g., intermediary client 50) that acquires a block confirmation transaction which is a transaction including a first merkle root hash calculated from a block header of a block in a target range in a first blockchain (e.g., blockchain 110) and a block number indicating a block of the target range, from a second blockchain (e.g., blockchain 120) which is the blockchain in which the block confirmation transaction is registered and which is different from the first blockchain; and an unauthorized operation verification means 82 (e.g., block management unit 41) that identifies a block in the first block chain from the block number included in the acquired confirmation transaction, calculates a second merkle root hash from the block header in the identified block, and compares whether the first merkle root hash and the second merkle root hash match to detect an unauthorized operation (e.g., data tampering) on the identified block.

Such a configuration allows the detection of unauthorized operations on data performed in the blockchain.

The target range in the first blockchain may be determined according to the timing of block generation in the first blockchain and the timing of block generation in the second blockchain.

Specifically, the target range in the first blockchain may be a range of the number of blocks in the first blockchain that are generated within a time period in which one block is generated in the second blockchain.

The first blockchain may be a consortium blockchain or public blockchain, and the second blockchain may be a public blockchain.

Specifically, the first merkle root hash and the second merkle root hash may be calculated in the same way.

FIG. 11 is a block diagram illustrating an overview of the confirmation generator according to the present invention. The confirmation generator 90 (e.g., the confirmation generator of the first exemplary embodiment described above) according to the present invention includes: a confirmation block generation means 91 (e.g., block management unit 21) that calculates a merkle root hash from a block header of a block in a target range in a first blockchain (e.g., blockchain 110), and generates a block confirmation transaction which is a transaction including a block number indicating a block of the target range and the calculated merkle root hash; and a registration request means 92 (e.g., intermediary client 30) that sends a transaction requesting registration of the block confirmation transaction to a second blockchain (e.g., blockchain 120) different from the first blockchain.

With such a configuration, even if data tampering occurs in the first blockchain, the tampering can be detected by a block confirmation transaction registered in the second blockchain.

FIG. 12 is a block diagram illustrating an overview of the fraud detection system according to the present invention. The fraud detection system 170 (e.g., fraud detection system 300) according to the present invention includes: a confirmation block generation means 71 (e.g., block management unit 21) that calculates a first merkle root hash from a block header of a block in a target range in a first blockchain (e.g., blockchain 110), and generates a block confirmation transaction which is a transaction including a block number indicating a block of the target range and the calculated first merkle root hash; a registration request means 72 (e.g., intermediary client 30) that sends a transaction requesting registration of the block confirmation transaction to a second blockchain (e.g., blockchain 120) different from the first blockchain; a confirmation block acquisition means 73 (e.g., intermediary client 50) that acquires the block confirmation transaction from the second blockchain; and an unauthorized operation verification means 74 (e.g., block management unit 41) that identifies a block in the first block chain from the block number included in the acquired confirmation transaction, calculates a second merkle root hash from the block header in the identified block, and compares whether the first merkle root hash and the second merkle root hash match to detect an unauthorized operation (e.g., data tampering) on the identified block.

With such a configuration, even if data tampering occurs in the first blockchain, the tampering can be detected by a block confirmation transaction registered in the second blockchain.

Some or all of the above exemplary embodiments may also be described as, but not limited to the following.

(Supplementary note 1) A fraud verification device comprising: a confirmation block acquisition means that acquires a block confirmation transaction which is a transaction including a first merkle root hash calculated from a block header of a block in a target range in a first blockchain and a block number indicating a block of the target range, from a second blockchain which is a blockchain in which the block confirmation transaction is registered and which is different from the first blockchain; and an unauthorized operation verification means that identifies a block in the first block chain from the block number included in the acquired confirmation transaction, calculates a second merkle root hash from the block header in the identified block, and compares whether the first merkle root hash and the second merkle root hash match to detect an unauthorized operation on the identified block.

(Supplementary note 2) The fraud verification device according to Supplementary note 1, wherein the target range in the first blockchain is determined according to the timing of block generation in the first blockchain and the timing of block generation in the second blockchain.

(Supplementary note 3) The fraud verification device according to Supplementary note 1 or 2, wherein the target range in the first blockchain is a range of the number of blocks in the first blockchain that are generated within a time period in which one block is generated in the second blockchain.

(Supplementary note 4) The fraud verification device according to any one of Supplementary notes 1 to 3, wherein the first blockchain is a consortium blockchain or public blockchain, and the second blockchain is a public blockchain.

(Supplementary note 5) The fraud verification device according to any one of Supplementary notes 1 to 4, wherein the first merkle root hash and the second merkle root hash are calculated in the same way.

(Supplementary note 6) A confirmation generator comprising: a confirmation block generation means that calculates a merkle root hash from a block header of a block in a target range in a first blockchain, and generates a block confirmation transaction which is a transaction including a block number indicating a block of the target range and the calculated merkle root hash; and a registration request means that sends a transaction requesting registration of the block confirmation transaction to a second blockchain different from the first blockchain.

(Supplementary note 7) The fraud verification device according to Supplementary note 6, wherein the target range in the first blockchain is determined according to the timing of block generation in the first blockchain and the timing of block generation in the second blockchain.

(Supplementary note 8) A fraud detection system comprising: a confirmation block generation means that calculates a first merkle root hash from a block header of a block in a target range in a first blockchain, and generates a block confirmation transaction which is a transaction including a block number indicating a block of the target range and the calculated first merkle root hash; a registration request means that sends a transaction requesting registration of the block confirmation transaction to a second blockchain different from the first blockchain; a confirmation block acquisition means that acquires the block confirmation transaction from the second blockchain; and an unauthorized operation verification means that identifies a block in the first block chain from the block number included in the acquired confirmation transaction, calculates a second merkle root hash from the block header in the identified block, and compares whether the first merkle root hash and the second merkle root hash match to detect an unauthorized operation on the identified block.

(Supplementary note 9) The fraud detection system according to Supplementary note 8, wherein the target range in the first blockchain is determined according to the timing of block generation in the first blockchain and the timing of block generation in the second blockchain.

(Supplementary note 10) A fraud verification method comprising: acquiring a block confirmation transaction which is a transaction including a first merkle root hash calculated from a block header of a block in a target range in the first blockchain and a block number indicating a block of the target range, from a second blockchain which is a blockchain in which the block confirmation transaction is registered and which is different from the first blockchain; and identifying a block in the first block chain from the block number included in the acquired confirmation transaction, calculating a second merkle root hash from the block header in the identified block, and comparing whether the first merkle root hash and the second merkle root hash match to detect an unauthorized operation on the identified block.

(Supplementary note 11) The fraud verification method according to Supplementary note 10, wherein the target range in the first blockchain is determined according to the timing of block generation in the first blockchain and the timing of block generation in the second blockchain.

(Supplementary note 12) A fraud detection method comprising: calculating a first merkle root hash from a block header of a block in a target range in a first blockchain, and generating a block confirmation transaction which is a transaction including a block number indicating a block of the target range and the calculated first merkle root hash; sending a transaction requesting registration of the block confirmation transaction to a second blockchain different from the first blockchain; acquiring the block confirmation transaction from the second blockchain; and identifying a block in the first block chain from the block number included in the acquired confirmation transaction, calculating a second merkle root hash from the block header in the identified block, and comparing whether the first merkle root hash and the second merkle root hash match to detect an unauthorized operation on the identified block.

(Supplementary note 13) The fraud detection method according to Supplementary note 12, wherein the target range in the first blockchain is determined according to the timing of block generation in the first blockchain and the timing of block generation in the second blockchain.

(Supplementary note 14) A program storage medium storing a fraud verification program causing a computer to perform: confirmation block acquisition processing of acquiring a block confirmation transaction which is a transaction including a first merkle root hash calculated from a block header of a block in a target range in the first blockchain and a block number indicating a block of the target range, from a second blockchain which is a blockchain in which the block confirmation transaction is registered and which is different from the first blockchain; and unauthorized operation verification processing of identifying a block in the first block chain from the block number included in the acquired confirmation transaction, calculating a second merkle root hash from the block header in the identified block, and comparing whether the first merkle root hash and the second merkle root hash match to detect an unauthorized operation on the identified block.

(Supplementary note 15) The program storage medium storing the fraud verification program according to Supplementary note 14, wherein the target range in the first blockchain is determined according to the timing of block generation in the first blockchain and the timing of block generation in the second blockchain.

(Supplementary note 16) A program storage medium storing a confirmation generation program causing a computer to perform: confirmation block generation processing of calculating a merkle root hash from a block header of a block in a target range in a first blockchain, and generating a block confirmation transaction which is a transaction including a block number indicating a block of the target range and the calculated merkle root hash; and registration request processing of sending a transaction requesting registration of the block confirmation transaction to a second blockchain different from the first blockchain.

Although the invention has been described above with reference to exemplary embodiments and examples, the invention is not limited to the above exemplary embodiments and examples. Various changes can be made in the composition and details of the present invention that can be understood by those skilled in the art within the scope of the present invention.

This application is based on Japanese patent application 2020-28430 and claims priority based on and the entire disclosure thereof is hereby incorporated.

### REFERENCE SIGNS LIST

1 Client device
10 Node
11 Control unit
12 Storage unit
20, 40, 60 Transaction management unit
21, 41 Block management unit
30, 50, 70 Intermediary client
100, 200, 300 Fraud detection system
110 Blockchain
120 Blockchain

What is claimed is:

1. A fraud verification device comprising:
a memory storing instructions; and
one or more processors configured to execute the instructions to:
acquire a block confirmation transaction which is a transaction including a first merkle root hash calculated from a block header of a block in a target range in a first blockchain and a block number indicating a block of the target range, from a second blockchain which is a blockchain in which the block confirmation transaction is registered and which is different from the first blockchain; and
identify a block in the first block chain from the block number included in the acquired block confirmation transaction, calculate a second merkle root hash from the block header in the identified block, and compare whether the first merkle root hash and the second merkle root hash match to detect an unauthorized operation on the identified block.

2. The fraud verification device according to claim 1, wherein
the target range in the first blockchain is determined according to the timing of block generation in the first blockchain and the timing of block generation in the second blockchain.

3. The fraud verification device according to claim 1, wherein
the target range in the first blockchain is a range of the number of blocks in the first blockchain that are generated within a time period in which one block is generated in the second blockchain.

4. The fraud verification device according to claim 1, wherein
the first blockchain is a consortium blockchain or public blockchain, and the second blockchain is a public blockchain.

5. The fraud verification device according to claim 1, wherein
the first merkle root hash and the second merkle root hash are calculated in the same way.

6. A confirmation generator comprising:
a memory storing instructions; and
one or more processors configured to execute the instructions to:
calculate a merkle root hash from a block header of a block in a target range in a first blockchain, and generate a block confirmation transaction which is a transaction including a block number indicating a block of the target range and the calculated merkle root hash; and
send a transaction requesting registration of the block confirmation transaction to a second blockchain different from the first blockchain.

7. The fraud verification device according to claim 6, wherein
the target range in the first blockchain is determined according to the timing of block generation in the first blockchain and the timing of block generation in the second blockchain.

8. A fraud detection system comprising:
a memory storing instructions; and
one or more processors configured to execute the instructions to:
calculate a first merkle root hash from a block header of a block in a target range in a first blockchain, and generate a block confirmation transaction which is a transaction including a block number indicating a block of the target range and the calculated first merkle root hash;
send a transaction requesting registration of the block confirmation transaction to a second blockchain different from the first blockchain;
acquire the block confirmation transaction from the second blockchain; and
identify a block in the first block chain from the block number included in the acquired block confirmation transaction, calculate a second merkle root hash from the block header in the identified block, and compare whether the first merkle root hash and the second merkle root hash match to detect an unauthorized operation on the identified block.

9. The fraud detection system according to claim 8, wherein
the target range in the first blockchain is determined according to the timing of block generation in the first blockchain and the timing of block generation in the second blockchain.

10-16. (canceled)
